(19) United States
(12) Patent Application Publication
(10) Pub. No.: US 2007/0244935 A1
(43) Pub. Date: Oct. 18, 2007

(54) Method, system, and computer-readable medium to provide version management of documents in a file management system

(76) Inventor: Aleksey G. Cherkasov, Covington, GA (US)

Correspondence Address: McIntyre Harbin & King, 500 Ninth Street SE, Washington, DC, 20003, US

(21) Appl. No.: 11/783,912

(22) Filed: Apr. 13, 2007

Related U.S. Application Data
(60) Provisional application No. 60/792,315, filed on Apr. 14, 2006.

(51) Int. Cl. G06F 17/30

(52) U.S. Cl. 707/203

(57) ABSTRACT

A method, system, and computer-readable medium to provide version management of a compound document in a document management system where the compound document includes multiple component files. The method comprises assigning a version number to the compound document, enabling a user to index the version number according to a change in any one of the component files, assigning a respective component version number to respective component files, enabling a user to index the component file version number according to changes therein, maintaining a record of component version numbers associated with each version of the compound document, and retrieving a version of a compound document by retrieving the associated versions of the component files. The method may be implemented in a multi-user system over a LAN or WAN network, and component files may be stored on a central networked file server as images accessible by the multiple users.

### CROSS-REFERENCE TO RELATED PATENTS AND PATENT APPLICATIONS

This invention claims the benefit of Provisional Application Ser. No. 60/792,315 entitled “Document Management System, Method, and Computer-Readable Medium o Effect Implementation Thereof,” filed Apr. 14, 2006, which application in its entirety is incorporated by reference herein.

### BACKGROUND

This invention relates to document or file management, but more specifically, to a method, system, and computer-readable medium to manage, control, or maintain successive versions of a document comprising multiple overlaid image fields or components, i.e., a compound document.

In the context of document or file management, a compound document comprises multiple segments or component files that are visually overlaid so that it appears on a display monitor as a single image. Each component file of the compound document may comprise text or pictures intermingled with multimedia annotations (text or graphic) such as pictures, digital audio or video, and/or other content. In a document management system, an image processor accesses each component file from memory and combines them to form a single image representation of the document. Segmentation of the respective image fields is generally transparent to the user. During work-flow processing, however, any subpart of a compound document may be updated, such as by editing, adding or deleting a file and thus, version management may become challenging. Together, multiple electronic image and/or text files comprising a set of component files that make up the compound document are herein called an “ImageSet.”

To facilitate work flow processing during file management, it is desirable to control or track versions of each individual component of a compound document. Present day document or file management systems, however, do not conveniently provide this ability. No prior system is known that allows for versioning of the individual component files of the ImageSet independently from each other or independently from the ImageSet as a whole.

The present invention, on the other hand, provides an audit trail for changes made to individual “ImageData” files comprising the ImageSet, i.e., the compound document as a whole. Advantageously, version control affords the user the ability to conveniently revert back to a previous version of a compound document. For example, the present invention allows a user to start with a single text document, later add an image overlay or annotation to the document, and then keep adding annotations to the overlay over a period of time as well as to modify content of the text document. Later, the user may trace all changes made to the collection of electronic documents by observing how they took place in chronological order. The user will thus be able to access previous states of the compound documents and to see them in the context of the collection at each point in time.

Prior systems do not provide this capability or other advantages of the present invention, which will become apparent upon reviewing of the following description taken with the accompanying drawings.

### SUMMARY OF THE INVENTION

A first aspect of the invention comprises a method of providing version management of a compound document in a document or file management system where the compound document includes at least two component files.

The method comprises assigning a version number to the compound document, enabling a user to index the version number of the compound document according to a change in any one of the multiple component files thereof, assigning a respective component version number to respective ones of the component files, enabling a user to index the version number of the component files according to a change therein, maintaining a record of component version numbers associated with each version of the compound document, and retrieving a given version of the compound document by retrieving the associated versions of the component files. The method may be implemented in a multi-user document or file management system over a LAN or WAN network, and the component files of the compound document may be stored on a central networked file server either as text or images that are accessible by the multiple users.

Another aspect of the invention comprises a method of maintaining respective versions of a compound document that includes multiple component files that each have a respective version of their own. The method comprises providing a collective indicia of version for the compound document according to each unique set of component files; enabling a user to change a component file by adding, deleting, or editing any one of the component files; providing a record of each unique set of the component files for each unique version of the compound document; and retrieving a version of the compound document by retrieving each component file in a unique set associated with the unique version of the compound document.

A further aspect of the invention comprises a method of storing and retrieving a version of a compound document where a unique version thereof includes a unique set of component data files. This aspect comprises providing a primary version number for a compound document having an initial set of component data files, enabling a user to alter a component file, assigning a secondary version number for each altered component file, providing associated secondary version numbers of component files for each primary version number of said compound document, and retrieving a compound document having a desired primary version number by retrieving versions of component files having associated secondary version numbers.

Another aspect of the invention comprises a document or file management system to enable a user to maintain a version of a compound document having multiple component files. Such a system comprises a user interface to permit a user to assign a version number to a compound document having multiple component files, to index the version number of the compound document according to a change in any one of the multiple component files thereof, to assign a respective component version number to the multiple component files of the compound document, and to index the component version number according to a change in a component file; a memory to store a record of component version numbers that are associated with each version of the compound document, and a processor that responds to user commands to retrieve a given version of the compound document by retrieving the associated component files associated with said given version.

A further aspect of the invention comprises a document or file management system that maintains respective versions of a compound document comprising at least two component files that each have a respective version. Such a system comprises a user workstation to enable a user to provide an indicia for a version of the compound document according to each unique set of component files and to change a component file by adding, deleting, or editing the component file; a memory to store a record of each unique set of the component files for each version of the compound document; and a processor that responds to a user request to retrieve a version of the compound document by retrieving each component file in a unique set associated with the version of the compound document.

A further aspect of the invention comprises a file management system to store and retrieve a version of a compound document having unique versions that respectively include unique sets of component data files. Such a system comprises a workstation to enable a user to provide a primary version number for a compound document having an initial set of component data files, to alter a component file, to assign a secondary version number for each altered component file, to provide associated secondary version numbers of component files for each primary version number of said compound document, and to retrieve a compound document of a desired primary version number by retrieving component data files having secondary version numbers associated with said primary version number.

There is also provided an additional aspect of the invention in the form of a computer-readable medium for use in a document or file management system to store and retrieve a version of a compound document having unique versions that respectively include unique sets of component data files. The medium comprises program instructions to effect operation by a processor in a file management system to enable a user (i) to provide a primary version number for a compound document having an initial set of component data files, (ii) to alter a component file, (iii) to assign a secondary version number for each altered component file, (iv) to provide associated secondary version numbers of component files for each primary version number of said compound document, and (v) to retrieve a compound document of a desired primary version number by retrieving component data files having secondary version numbers associated with said primary version number.

Other aspects, features, and embodiments of the invention will become apparent upon review of the following description taken in connection with the accompanying drawings. The invention, though, is pointed out with particularity by the appended claims.

### BRIEF DESCRIPTION OF THE DRAWINGS

FIG. 1 shows a compound document comprising a text document file and a callout note file.

FIG. 2 conceptually illustrates interlinking between a compound document as a whole (i.e., an “ImageSet”) and respective component files (i.e., “ImageData files”) of the compound document.

FIG. 3 conceptually illustrates cross-referencing or interlinking between a compound document (“ImageSet”) and a version of a component file (“ImageData”) thereof.

FIG. 4 conceptually illustrates cross-referencing or interlinking between a Version 2 compound document (“ImageSet”) and respective versions of component files (“ImageData”) after adding an audio file to the compound document.

FIG. 5 conceptually illustrates cross-referencing or interlinking between a Version 3 compound document (“ImageSet”) and respective versions of component files (“ImageData”) after editing a document component of the compound document.

FIG. 6 conceptually illustrates cross-referencing or interlinking between a Version 4 compound document (“ImageSet”) and respective versions of component files (“ImageData”) after deleting the audio component from the compound document.

FIG. 7 show an apparatus the may be used to carryout the various methods and systems according to the invention.

### DESCRIPTION OF ILLUSTRATIVE EMBODIMENTS

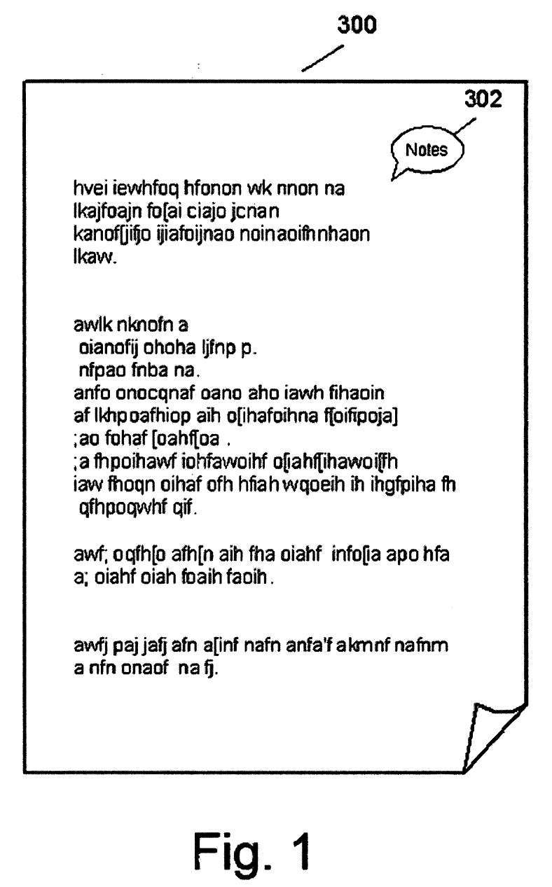

A compound electronic document (herein called an “ImageSet”) comprises multiple elementary documents or files, each of which is herein called an “ImageData” file. FIG. 1 shows an example of a compound document comprising a text document component 300 with a graphic annotation component 302 in the form of a callout note overlaid over the text component. Each subpart or component of the compound document is separately stored in memory as an image file that is typically accessed and retrieved during workflow processing in a document management system. Alternatively, a version of the compound document may be stored as a single file. Instead of text with a graphical callout, a compound document may also comprise a picture with graphical annotation marks applied to the document image and presented to a user as a single document (e.g., the user sees on a computer monitor the combined subparts as a single document).

Document 300 and annotation mark 302 overlaid therewith, however, are preferably stored as separate “ImageData” items, or data files. The two “ImageData” items of FIG. 1 comprise a single “ImageSet,” which may also include additional annotations or overlaid marks. Another example of a compound document is a text document with associated audio comments where the audio and text files are stored as separate “ImageData” items, one being stored as a digital audio file (e.g., in .wav format) and the other being stored as a text file in text format (e.g., .txt format). When rendered, the audio is played back upon viewing the visual component of the compound document. Because a compound document is a bundle of multiple individual files and because any one of the bundled files (including the principal document) may individually be altered or deleted, versior control of the compound document becomes challenging. For example, it is difficult to determine how to identify or denote a particular version of a compound document in situations where any one of its subparts may be added, altered, deleted, or modified.

To provide an example of how the present invention is practiced, FIG. 2 conceptually illustrates a compound document denoted as ImageSet 304 having an integer field 303 to identify a version number for the compound ImageSet document. Any type of indicia (other than numbers) may be used to identify a version number. Typically, a memory location or database record identifies the whereabouts of the compound in memory storage, which may comprise a local or networked file server. Using conventional cross-referencing techniques, the compound document 304 is interlinked with each of its ImageData component files that make up the compound document, one being conceptually represented as ImageData file 306. Each ImageData file 306 also has an integer field 305 that specifies a version number, as well as image or text data 307 and a data type identifier 309. Only one ImageData file is shown in FIG. 2, it being understood that an ImageSet may comprise multiple ImageData or component files.

According to an aspect of the present invention, version control of the compound document is achieved by separately storing in a database record (or other memory storage) every version of the ImageSet 304 where each record (or storage location) references particular sets and versions of the ImageData files comprising the ImageSet 304.

For example, a user creates an electronic document and decides to place it into a document management system. As illustrated in FIG. 3, the system or method implementing version control responds by creating an ImageSet object 310 of Version 1 that cross-references a set of ImageData files 312 containing one or more electronic documents that constitute Version 1, e.g., a collective indicia of a version to reference the compound document and the callout note. ImageSet object 310, for example, may comprise a series of data records each corresponding to a respective ImageData file. As known in the art, computer implementation is achieved by a set of program instructions executed by a data processing system, which program instructions may be accessed or downloaded from a local or networked memory storage device.

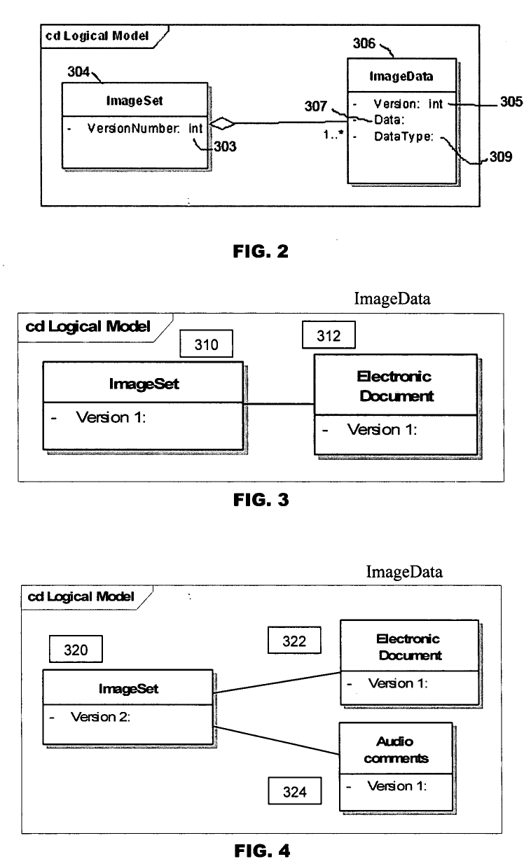

At a later point in time, as illustrated in FIG. 4, a user decides to add audio comments to the compound document in order to create a new Version 2 ImageSet 320. Version 1 of audio comments created by the user is stored in memory as a separate audio file, but referenced by ImageData 324 as audio comments Version 1. ImageSet 320, however, references or comprises both Version 1 ImageData file 322 and Version 1 ImageData “Audio Comments” file 324. As previously indicated, separate ImageData files 322 and 324 may be separately stored in a database and referenced or called via string variables or by way of address pointers in data records of ImageSet 320.

To illustrate a potential typically challenge encountered during version management of a compound document, the user subsequently finds a spelling error in the Image Data “Electronic Document” file 322 and decides to correct it.

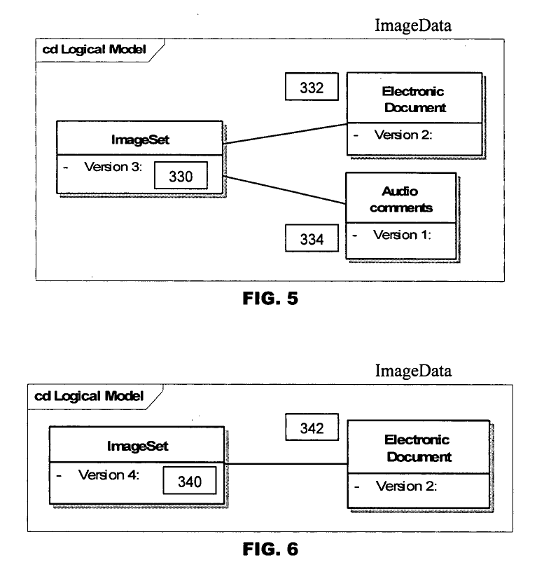

Correction then produces a new Version 3 ImageSet file 330 that contains Version 2 “Electronic Document” file 332 of and Version 1 “Audio Comments” file 334, as shown in FIG. 5.

Finally, a user may decide to delete the ImageData “Audio Comments” file 334 whereby to create a new Version 4 “ImageSet” file 340 that references only the Version 2 “Electronic Document” ImageData file 342. This is illustrated in FIG. 6. During workflow processing, multiple users generally have access to the compound document over local or wide area network, and each such may make alteration or changes, thus further complicating version management.

As illustrated, a new ImageSet version number is created every time when at least one of the ImageData elements is modified, added to the ImageSet, or deleted from the ImageSet. According to various aspect of the present invention, the document or file management system tracks previous version of the compound ImageSet document and is able to retrieve exact versions of documents at any given moment of time. The illustrated system stores all versions of ImageData in a document or file storage memory device so that they may be recalled during version control or management.

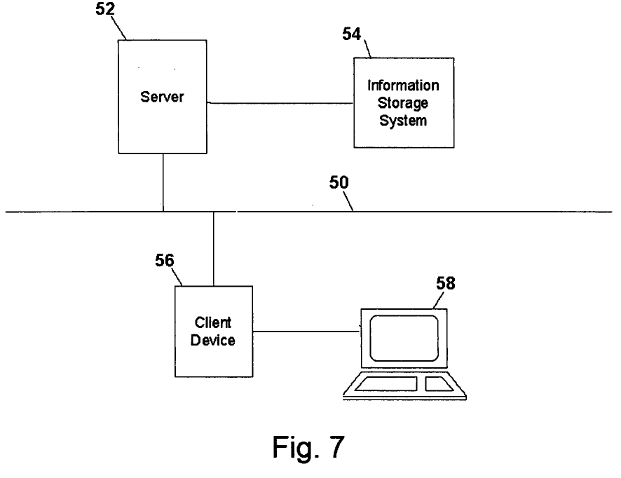

FIG. 7 shows a generic system in which the various methods may be implemented in a document or file management system. As illustrated, a network 50 provides a communication backbone for a workstation comprising a client device 56 and display monitor 58. Network 50 may comprise a local area network (LAN) or a wide area network (WAN), or a combination. Only one workstation is shown but a typical network supports many users. A server 52 on network 50 generally implements the document or file management system to manage compound documents stored on a central file server 54. Server 54 may comprise an image and/or text file server for the various component files of the compound document.

According to one embodiment of the invention, workstation 56, 58 includes a processor that responds to program instructions to provide a user interface to permit a user to assign a version number to a compound document having multiple component files, to index the version number of the compound document according to a change in any one of the multiple component files thereof stored locally in the client device 56 or stored on the central file server 54, to assign a respective component version number to the multiple component files of the compound document, and to index the component version number according to a change in a component file. Indexing may simply comprise increasing or decreasing an integer or decimal number to denote a version.

Either central file storage 54 or a local storage device 56 includes a memory to store a record of component version numbers that are associated with each version of the compound document. A processor included in the local client device 56 responds to user commands to retrieve a given version of the compound document by retrieving from memory the associated component files associated with said given version.

Any one of the component files may have version indicia, or also may be “fixed” in the sense of being permanently recorded or archived. A version number or indicia may include an integer or decimal number, an alphanumeric character, or any other symbol to designate or indicate a unique version of a document or file. Altering or changing a file includes adding, deleting, masking, annotating, editing, or any other operation that in any way changes or alters information in a component or subpart of a compound document. Accordingly, based on the teachings herein, the invention defined by the appended claims embraces variations and modifications of the disclosed embodiments as may come to those skilled in the art.

I claim:

1. A method of providing version management of a compound document in a document management system where the compound document includes multiple component files, said method comprising:
assigning a version number to the compound document,
enabling a user to index the version number of the compound document according to a change in any one of the component files,
assigning a respective version number to respective component files of the compound document,
enabling a user to index the version number of the component files according to a change therein,
maintaining a record of version numbers of component files associated with each version of the compound document, and
retrieving a given version of the compound document by retrieving the associated versions of component files thereof.

2. A method of maintaining respective versions of a compound document that includes multiple component files that have a respective version, said method comprising:
providing a collective indicia of version for said compound document according to each unique set of component files,
enabling a user to change a component file by adding, deleting, or editing any one of said component files,
providing a record of each unique set of said component files for each unique version of said compound document, and
retrieving a version of said compound document by retrieving each component file in a unique set associated with said unique version.

3. A method of storing and retrieving a version of a compound document where a unique version thereof includes a unique set of component files, said method comprising:
providing a primary version number for the compound document having an initial set of component files,
enabling a user to alter a component file,
assigning a secondary version number for each altered component file,
providing associated secondary version numbers of component files for each primary version number of said compound document, and
retrieving a compound document having a desired primary version number by retrieving versions of component files having associated secondary version numbers.

4. A document management system to enable a user to maintain a version of a compound document having multiple component files, said system comprising:
a user interface to permit a user to assign a version number to a compound document having multiple component files, to index the version number of the compound document according to a change in any one of the multiple component files thereof, to assign a respective component version number to the multiple component files of the compound document, and to index the component version number according to a change in a component file;
a memory to store a record of component version numbers that are associated with each version of the compound document, and
a processor that responds to user commands to retrieve a given version of the compound document by retrieving the associated component files associated with said given version.

5. A file management system that maintains respective versions of a compound document comprising at least two component files that each have a respective version, said system comprising:
a user workstation to enable a user to provide an indicia for a version of said compound document according to each unique set of said at least two component files and to change a component file by adding, deleting, or editing said component file;
a memory to store a record of each unique set of said component files for each version of said compound document; and
a processor that responds to a user request to retrieve a version of said compound document by retrieving each component file in a unique set associated with said version.

6. A file management system to store and retrieve a version of a compound document having unique versions that respectively include unique sets of component data files, said system comprising:
a workstation to enable a user to provide a primary version number for a compound document having an initial set of component data files, to alter a component file, to assign a secondary version number for each altered component file, to provide associated secondary version numbers of component files for each primary version number of said compound document, and to retrieve a compound document of a desired primary version number by retrieving component data files having secondary version numbers associated with said primary version number.

7. A computer-readable medium for use in a file management system to store and retrieve a version of a compound document having unique versions that respectively include unique sets of component data files, said medium comprising program instructions to effect operation of a processor in a file management system to enable a user (i) to provide a primary version number for a compound document having an initial set of component data files, (ii) to alter a component file, (iii) to assign a secondary version number for each altered component file, (iv) to provide associated secondary version numbers of component files for each primary version number of said compound document, and (v) to retrieve a compound document of a desired primary version number by retrieving component data files having secondary version numbers associated with said primary version number.
